(19) United States
(12) Patent Application Publication
(10) Pub. No.: US 2026/0366988 A1
(43) Pub. Date: Nov. 19, 2026

(54) OPTICAL MICROCELL METHODS AND APPARATUS

(71) Applicant: University of Maribor, Maribor (SI)

(72) Inventors: Vedran Budinski, Maribor (SI); Denis Donlagic, Maribor (SI)

(21) Appl. No.: 19/212,651

(22) Filed: May 19, 2025

(51) Int. Cl. G01N 21/05; G01N 21/03; G02B 6/028; G02B 6/38

(52) U.S. Cl. CPC G01N 21/05; G02B 6/0281; G02B 6/3825; G01N 2021/0346; G01N 2021/052

(57) ABSTRACT

In some embodiments, an optical fiber microcell may be configured to be integrated with a fluid delivery system and include a lead-in optical fiber coupled to an optical field adapter, which is coupled to a main capillary. On the other side of the main capillary is another optical field adapter coupled to the main capillary, followed by a lead-out optical fiber coupled to the other field adapter. One or both optical field adapters may have microcapillaries to deliver a fluid to be analyzed into the microcell. Methods of assembling an optical fiber microcell are also provided, as are other aspects.

### FIELD

This disclosure relates to optical microcells and, more particularly, to microcells integrated with optical fibers.

### BACKGROUND

Optical analysis of fluids including liquids, gases, and vapors, often employs measurement of optical properties including absorption, refractive index, and wavelength dependent optical absorption. Furthermore, fluids are often excited by light while an optical response of the fluid is observed, for example, in a fluorescence-based analysis.

In a number of indirect measurement methods, including photo-thermal spectroscopy, a fluid is heated or otherwise excited by a laser while a refractive index or other changes in optical properties of the fluid are observed. There are numerous other applications where interactions between light and fluid are used in industry, mostly for fluid analysis, to promote light-induced chemical reactions, and to measure external fields, such as, for example, magnetic or electric fields. The emerging area of quantum applications also often requires confinement of functional fluids, mostly gases or vapors, while providing optical interaction of light with these fluids at one or more selected optical wavelengths.

All these applications require optical microcells which confine fluids and provide interactions with light. It is often desired that microcells be small and coupled to optical fibers. Small dimensions of microcells provide many advantages including compact and cost-efficient measurement system design and a need for only small volumes of fluids to be analyzed.

The use of optical fibers allows for versatile coupling of a microcell to optical sources and readout systems and for remote or in-situ use of microcells. This is of special importance when the sensing system is used in remote and harsh environments. Full fiber-coupled microcells provide immunity to electromagnetic interference, small size, low cost, and the possibility for quasi-distributed measurements.

Different fiber designs, including fibers with a small hole in the center of the core and D-shaped optical fibers have previously been employed in fluid sensing. However, such fiber sensors suffer from a poor overlap between the fluid volume and the mode field of propagating light, which results in weak absorption and, therefore, long lengths of fibers are required. The overlap between the fluid and mode field was greatly improved by employing photonic bandgap fibers.

Since the advent of hollow-core photonic crystal fibers (HC-PCFs) and because of their functional properties, HC-PCFs have been attracting a lot of attention for developing fluid sensing cells. The hollow-core structural design of these fibers offers appropriate light-gas interaction due to relatively low transmission losses, where the interaction between light and gas can be further enhanced by increasing the fiber length. Hollow-core photonic crystal fibers, however, provide limited cross section which may limit fluid flow rates, have inner walls that are usually not smooth resulting in higher contamination concerns, are complex for production, and are more difficult to manipulate and use during microcell production processes.

Besides an adequate sensing cell design, ensuring an efficient and robust fluid delivery system to the sensing cell is also desirable. In this case, employing PCF fibers can present a disadvantage because of their structure, which makes it difficult to couple them with an efficient fluid delivery system. Typical configurations employ coupling chambers. A lead optical fiber and PCF are then axially aligned within the coupling chamber to allow optical coupling between the fiber and the PCF, while providing a gap or similar separation between end-faces of the lead fiber and the PCF to allow the flow of fluid into or out of the PCF. To reduce the light coupling losses in such setups, additional collimation lenses of specialized fiber assemblies are inserted in between the lead fiber and PCF. This approach increases the size and complexity of cell manufacturing and the volume of the coupling chamber and generally increases the measurement system response time. Precise mechanical alignment among lead fibers and PCF, which must be maintained throughout the device lifespan, makes these solutions bulky and vibrationally and thermally sensitive, thus restricting use of these sensors in in-situ measurement applications.

Improved optical microcell sensors are accordingly desired.

### SUMMARY

A fiber coupled microcell is disclosed herein that, in some embodiments, may utilize an ordinary capillary to provide fluid confinement and light guidance within the microcell, which is configured to incorporate a fully integrated fluid delivery system. The solution, according to embodiments of the invention, may provide a monolithic design that is compact and can operate under harsh conditions.

In some embodiments, a robust fiber microcell for fluid, atomic, or molecular sensing is provided. The fiber microcell may include a capillary and a device which confines a fluid of interest to be analyzed. The capillary has an inner diameter, an outer diameter, and an inner cross-section that acts as a lossy waveguide.

In some embodiments, an optical fiber microcell for optical analysis of a fluid includes a first lead optical fiber and a first optical field adapter. The first lead optical fiber has a first end and a core, and the first optical field adapter has a first end and a second end, wherein the first end of the first optical field adapter is contiguously attached to the first end of the first lead optical fiber. The first lead optical fiber is configured to guide a light wave into the first optical field adapter. The optical fiber microcell also includes a main capillary having a first end contiguously attached to the second end of the first optical field adapter, wherein the main capillary also has a second end and a hollow core, the hollow core having an inner diameter. The first optical field adapter is configured to expand and guide the light wave received from the first lead optical fiber into the main capillary. The main capillary is configured to contain in the hollow core a fluid to be analyzed. The optical fiber microcell further includes a second optical field adapter and a second lead optical fiber. The second optical field adapter has a first end and a second end, wherein the first end of the second optical field adapter is contiguously attached to the second end of the main capillary. The second lead optical fiber has a first end and a core, wherein the first end of the second lead optical fiber is contiguously attached to the second end of the second optical field adapter. The second optical field adapter is configured to focus light received from the main capillary into the core of the second lead optical fiber.

In some embodiments, a method of assembling an optical fiber microcell for optical analysis of a fluid includes contiguously attaching a first end of a first lead optical fiber to a first end of a first optical field adapter, wherein the first optical field adapter has an optical fiber configured to expand a light wave received from the first lead optical fiber and guide the expanded light wave through a second end of the first optical field adapter. The method also includes contiguously attaching a first end of a main capillary to the second end of the first optical field adapter, wherein the main capillary has a hollow core, and the hollow core has an inner diameter. The method further includes contiguously attaching a first end of a second optical field adapter to a second end of the main capillary and contiguously attaching a first end of a second lead optical fiber to a second end of the second optical field adapter.

Still other aspects, features, and advantages of this disclosure may be readily apparent from the following detailed description and illustration of a number of example embodiments and implementations, including the best mode contemplated for carrying out the invention. This disclosure may also be capable of other and different embodiments, and its several details may be modified in various respects, all without departing from the scope of the invention.

### BRIEF DESCRIPTION OF DRAWINGS

The drawings, described below, are for illustrative purposes and are not necessarily drawn to scale. Accordingly, the drawings and descriptions are to be regarded as illustrative in nature, and not as restrictive. The drawings are not intended to limit the scope of the invention in any way.

FIG. 1 illustrates a schematic side view of an optical assembly with one fluid port on each side that may connect a main capillary hollow core having an inner volume with a fluid delivery system according to embodiments provided herein.

FIG. 2 illustrates a schematic side view of an optical assembly with one fluid port on each side of a main capillary hollow core having an inner volume, the fluid ports allowing connection of the inner volume of the main capillary with fluid delivery connection links according to embodiments provided herein.

FIG. 3 illustrates a schematic side view of an optical assembly with two or more fluid ports on each side that may connect a main capillary hollow core with a fluid delivery system according to embodiments provided herein.

FIG. 4 illustrates a schematic side view of an optical assembly utilizing optical fibers having cores with increased mode field diameters and one or more microcapillaries which contact a hollow core of a main capillary and fluid delivery connection links according to embodiments provided herein.

FIG. 5 illustrates a schematic side view of an optical assembly with an optical field adapter including one or more microcapillaries in optical fibers with a graded index profile according to embodiments provided herein.

FIG. 6 illustrates a schematic side view of an optical assembly with an optical field adapter including one or more microcapillaries in optical fibers with large mode field diameters according to embodiments provided herein.

FIG. 7 illustrates a schematic side view of an optical assembly with an optical field adapter including a sequence of two or more optical fibers with progressively larger mode field diameters integrated with one or more microcapillaries extending in one of the two or more optical fibers according to embodiments provided herein.

FIG. 8 illustrates a schematic side view of an optical assembly showing fabrication of microcapillaries, configured to be coupled to a fluid delivery system, by micro-drilling with a femtosecond laser according to embodiments provided herein.

FIG. 9 illustrates a schematic side view of an optical assembly with tilted field adapter surfaces to prevent appearance of Fabry-Perot interference inside the microcell according to embodiments provided herein.

FIGS. 10A-10G illustrate schematic cross-sectional views of different optical field adapters with microcapillaries or voids of diverse shapes, arrangements, and sizes according to embodiments provided herein.

FIGS. 11A-11C illustrate schematic cross-sectional views of different main capillary designs with different inner and outer diameters and microcapillaries or voids of diverse shapes and sizes according to embodiments provided herein.

FIG. 12 illustrates a schematic side view of a connection of an optical assembly to a fluid delivery system in which optical field adapters with ports and microcapillaries pass through side openings of fluid delivery capillaries according to embodiments provided herein.

FIG. 13 illustrates a schematic side view of a connection of an optical assembly to a fluid delivery system with a delivery capillary encapsulated in a short section of a large capillary with a diameter larger than the delivery capillary diameter according to embodiments provided herein.

FIG. 14 illustrates a schematic side view of a connection of an optical assembly to a fluid delivery system with delivery capillaries mounted on a side of an optical field adapter according to embodiments provided herein.

FIG. 15 illustrates a schematic side view of a connection of an optical assembly to a fluid delivery system with curved delivery capillaries according to embodiments provided herein.

FIG. 16 illustrates a schematic side view of a connection of an optical assembly to a fluid delivery system with small chambers according to embodiments provided herein.

FIG. 17 illustrates a schematic side view of a spectroscopic application set-up for continuous analysis of fluids according to embodiments provided herein.

FIG. 18 illustrates a schematic side view of a spectroscopic application set-up for analysis of a fluid with constant composition according to embodiments provided herein.

FIG. 19 illustrates a schematic side view of a spectroscopic application set-up for continuous analysis of fluids under vacuum according to embodiments provided herein.

FIG. 20 illustrates a flowchart of a method of assembling an optical fiber microcell according to embodiments provided herein.

### DETAILED DESCRIPTION

An optical fiber microcell according to some embodiments includes a first lead optical fiber, a first optical field adapter, a main capillary, a second optical field adapter, and a second lead optical fiber permanently bonded in series to form a monolithic structure as shown in one or more figures below. The first lead optical fiber includes cladding and a core and guides light received, for example, from a light source to the first optical field adapter. Light from the first optical field adapter propagates into the main capillary where it may interact with a fluid to be analyzed. At least a portion of the light that propagates through the main capillary (and any fluid to be analyzed stored therein) may then propagate through the second optical field adapter. The second lead optical fiber includes cladding and a core and guides light received from the second optical field adapter to an optical detector.

The optical field adapters are preferably optical fibers that include an outer edge (or side), cladding, a core, and one or more fluid ports (e.g., openings, voids, etc.) for receiving the fluid to be analyzed with the fiber microcell. The first and second optical field adapters may each have two functions. The first function of the first optical field adapter is to expand the optical field (also referred to herein as a light wave) of light received from the first lead optical fiber and guide it into the main capillary. The second function of the first optical field adapter is to guide the fluid via one or more fluid ports and microcapillaries into the inner volume (e.g. a hollow core) of the main capillary. A microcapillary refers to a channel, conduit, passageway, or the like for transporting a fluid (e.g., to or from the main capillary) and generally has a diameter or other cross section that is smaller than that of the main capillary.

The first function of the second optical field adapter is to focus a received optical field (light wave) exiting the main capillary into the second lead optical fiber. The second function of the second optical field adapter is to guide the fluid via one or more fluid ports and microcapillaries out of the main capillary. Note that the functions of the first and second optical field adapters can be reversed, wherein the second lead optical fiber guides light received, for example, from a light source to the second optical field adapter and so on wherein the first lead optical fiber guides light to an optical detector.

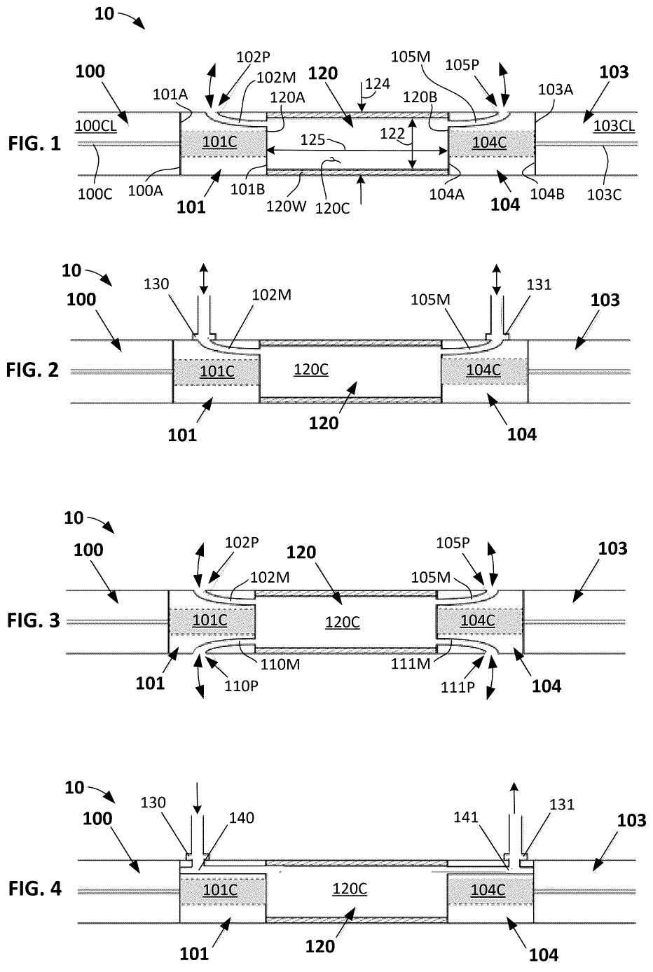

FIG. 1 illustrates an optical fiber microcell 10 according to one or more embodiments. Optical fiber microcell 10 includes a first lead optical fiber 100, a first optical field adapter 101 (having a fluid port 102P and microcapillary 102M), a main capillary 120, a second optical field adapter 104 (having a fluid port 105P and microcapillary 105M), and a second lead optical fiber 103. The first lead optical fiber 100 has a first end 100A and a core 100C. The first optical field adapter 101 has a first end 101A contiguously attached to first end 100A and a core 101C. In some embodiments, “contiguously attached” means connected throughout a boundary in an unbroken sequence along at least a portion of the boundary (e.g., along an entire boundary between a core of a lead optical fiber and a corresponding aligned core of an optical field adapter as described below).

The main capillary 120 has a first end 120A contiguously attached to a second end 101B of first optical field adapter 101, a second end 120B, an inner diameter 122 and an outer diameter 124 and a hollow core 120C (see FIG. 2) forming an inner volume defined by the capillary inner diameter 122 and a capillary length 125. The second optical field adapter 104 includes a first end 104A contiguously attached to second end 120B of main capillary 120, a second end 104B, and a core 104C. Fluid port 102P and microcapillary 102M are configured to allow a fluid to be transported through first optical field adapter 101 into main capillary 120 (for optical analysis) while fluid port 105P and microcapillary 105M of second optical field adapter 104 allow the fluid to be removed from main capillary 120. As stated, the fluid flow direction may be reversed, with fluid being introduced to main capillary 120 through second optical field adapter 104 and removed through first optical field adapter 101.

In general, each interface (e.g., the interface of first lead optical fiber 100 and first optical field adapter 101, the interface of first optical field adapter 101 and main capillary 120, the interface of main capillary 120 and second optical field adapter 104, and the interface of second optical field adapter 104 and second lead optical fiber 103) may be formed by contiguously attaching two components (e.g., connecting the components throughout a boundary in an unbroken sequence along at least a portion of the boundary). In one or more embodiments, an adhesive layer (not shown) and/or a thin film reflective layer (e.g., for an interferometer application for refractive index measurements) may be employed at one or more of these interfaces. However, direct coupling at each interface allows all components to be fused (e.g., melted and/or welded together) and may improve tensile strength of the overall assembly. While first lead optical fiber 100, first optical field adapter 101, second lead optical fiber 103 and second optical field adapter 104 are shown as having the same overall diameter, in some embodiments, one or more of these components may have a different diameter. For example, first optical field adapter 101 may have a larger diameter than first lead optical fiber 100 and/or second optical field adapter 104 may have a larger diameter than second lead optical fiber 103.

In some embodiments, first lead optical fiber 100, first optical field adapter 101, main capillary 120, second optical field adapter 104, and/or second lead optical fiber 103 may be formed from an amorphous material exhibiting low optical loss and/or that allows coupling of these components by fusion splicing. Example materials include, but are not limited to fused silica (e.g., amorphous SiO2) and doped-fused silica. Example dopants may include GeO2, P2O5, TiO2, B2O3, Al2O3, etc., with concentrations ranging from 0-30 molo. Other materials, dopants, and/or dopant concentrations may be employed. For example, alternative glasses with other compositions may be employed, as may be plastics such as polymethyl methacrylate (PMMA).

In some embodiments, first and second lead optical fibers 100, 103 (and/or first and second optical field adapters 101, 104 and/or main capillary 120) may have similar dimensions to that of standard telecom fibers (e.g., an outside diameter of 125 μm) as this provides compatibility with widely available telecom components and fiber handling tools. Other dimensions may be employed. More generally, to retain desirable flexural characteristics and ease of handling, first and second lead optical fibers 100, 103 may range from 80 to 250 μm in diameter (e.g., outside diameter). In other embodiments, fiber diameters of between 250 μm and 1 mm may be employed. In yet other embodiments, fiber diameters ranging from 80 μm to 1.5 mm may be employed. Other diameters may be used.

In one or more embodiments, the diameter of core 100C of first lead optical fiber 100 and/or the diameter of core 103C of second lead optical fiber 103 may be selected to support a single-mode operation of the fiber(s). Depending on the operational wavelength and desired bend loss tolerance of lead optical fiber 100 and/or 103, the diameter of core 100C and/or 103C may range between 2 and 15 μm, and in some embodiments between 4.5 and 11 μm. In some embodiments, core 100C and/or 103C may be a standard telecom single-mode fiber core with a diameter between 8 and 9 μm. Other diameters may be employed for core 100C and/or 103C.

The diameter of core 101C of first optical field adapter 101 may be larger than the diameter of core 100C of first lead optical fiber 100 and/or the diameter of core 104C of second optical field adapter 104 may be larger than the diameter of core 103C of second lead optical fiber 103. For example, in some embodiments, the diameter of core 101C and/or core 104C may range from 12 and 60 μm, and in other embodiments, between 14 and 30 μm, and in yet other embodiments, between 15 and 25 μm. Other diameters may be employed for core 101C of first optical field adapter 101 and/or for core 104C of second optical field adapter 104.

In some embodiments, main capillary 120 may be an empty cylinder or tube having an outer wall 120W that defines hollow core 120C of main capillary 120. In some embodiments, outer wall 120W of main capillary 120 may have a thickness of 5 to 250 μm, and in other embodiments 10 to 60 μm, although other outer wall thicknesses may be employed. In one or more embodiments, outer wall 120W may be formed from the same material used to form first lead optical fiber 100, second lead optical fiber 103, first optical field adapter 101, and/or second optical field adapter 104 or another material compatible with the material used for these components (e.g., fused silica or doped-fused silica).

Main capillary 120 may be formed using a fiber production process or a similar process. For example, main capillary 120 may be drawn at a high temperature from solid glass preforms or blanks that have a desired structure. That is, instead of drawing a solid fiber preform, a tube may be drawn (e.g., from pure or doped silica glass). Such a process may allow formation of a capillary of any desired length. Forming main capillary 120 from a material compatible with first optical field adapter 101 and second optical field adapter 104 allows fiber microcell 10 to be formed from short sections of optical fibers. The optical fibers and preformed capillary (for use as main capillary 120) may be cleaved to desired dimensions and fusion spliced together. Example dimensions are described further below.

As shown in FIG. 1, the first, second, or both optical field adapters 101 and 104 each include one or more fluid ports 102P, 105P and microcapillaries 102M, 105M that may connect the main capillary hollow core 120C with a fluid delivery system (not shown) that is configured to supply a fluid to be analyzed. Ports 102P and/or 105P, and/or microcapillaries 102M and/or 105M, may have a circular or otherwise-shaped cross section. In some embodiments, the diameter or main cross-sectional dimension of port 102P and/or 105P (and/or microcapillary 102M and/or 105M) may range from 3 to 100 μm, and in some embodiments from 10 to 40 μm. Other port and/or microcapillary diameters may be employed. Microcapillaries 102M and/or 105M may be of any desired length (e.g., as optical field adaptors 101 and 104 are waveguides and can guide light with low loss). In some embodiments, the length of microcapillaries 102M and/or 105M may range from 50 μm to 1 m, and in other embodiments, from 1 mm to 100 mm. However, in some cases, microcapillaries 102M and/or 105M may be considerably greater than 1 meter in length, especially if the fluid to be analyzed within main capillary 120 is a gas.

FIG. 2 illustrates fiber microcell 10 of FIG. 1 employing integrated fluid ports 130 and 131, such as external tubing connection members or other fluid delivery connection links, that may be employed for fluid delivery into microcapillaries 102M and 105M, respectively. For example, fluid ports 130 and 131 may be attached to first optical field adapter 101 and second optical field adapter 104, respectively, using a suitable adhesive. In this manner, a fluid may be delivered to and/or removed from hollow core 120C of main capillary 120 via the first, second, or both optical field adapters 101 and 104.

In some embodiments, as shown in FIG. 3, additional fluid ports 110P and 111P (and microcapillaries 110M and 111M) may be provided so that optical fiber microcell 10 may have two or more fluid ports/microcapillaries on each side of main capillary 120 that may connect main capillary hollow core 120C with a fluid delivery system.

In the embodiments of FIGS. 1-3, the microcapillaries are shown as having a curved or other arbitrary shape. Such microcapillaries may be formed by laser drilling, for example, using a femtosecond laser or other laser source. FIG. 4 illustrates an embodiment in which first optical field adapter 101 and/or second optical field adapter 104 have integrated microcapillaries (e.g., microcapillaries that may be produced during formation of the fiber sections used for the optical field adapters). Such microcapillaries run the length of the optical field adapters (e.g., parallel to a central axis and/or core region of the adapters). For example, in FIG. 4, first optical field adapter 101 includes a first microcapillary 140 that extends across the length of first optical field adapter 101. A first integrated port 130 is coupled to first microcapillary 140 for delivering fluid to main capillary 120 via first microcapillary 140. For example, after formation of first optical field adapter 101 with first microcapillary 140 formed therein, an opening may be drilled through a sidewall of first optical field adapter 101 to allow attachment of first integrated port 130 (e.g., via a suitable adhesive or fusion splicing). Second optical field adapter 104 with second microcapillary 141 and second integrated port 131 may be similarly formed. Example microcapillary diameters are described above with regard to microcapillaries 102M and 105M. Microcapillaries 140, 141 may be approximately centrally located within the cladding regions of optical field adapters 101, 104 or otherwise located. In the embodiment shown, microcapillaries 140, 141 extend longitudinally (e.g., as longitudinal microcapillaries).

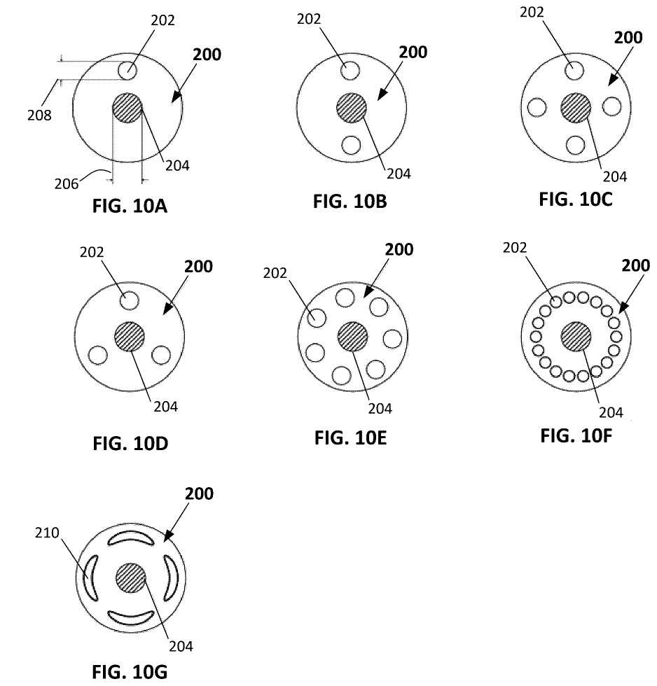

As shown in FIGS. 1-4, at least one of the optical field adapters 101 and 104 may contain a single microcapillary or multiple microcapillaries. Other microcapillary (and/or void) configurations may be employed within optical field adapter 101 and/or 104. For example, FIGS. 10A-10G are cross sectional views of various microcapillary and/or void configurations for an optical field adapter such as optical field adapter 101 and/or 104 in accordance with one or more embodiments. Each microcapillary and/or void may extend the length of each optical field adapter.

With reference to FIG. 10A, an optical field adapter 200 may include a single microcapillary 202 that extends a length of the optical field adapter 200 and has a core 204 with diameter 206. Such an optical field adapter 200 would look similar to first optical field adapter 101 of FIG. 4 when viewed from the side. Microcapillary 202 has a diameter 208. FIG. 10B illustrates an embodiment of optical field adapter 200 in which two microcapillaries 202 are provided. Such an optical field adapter 200 would look similar to first optical field adapter 101 of FIG. 8 when viewed from the side. FIGS. 10C-10E illustrate embodiments of optical field adapter 200 in which four, three, and six microcapillaries 202, respectively, are provided. As shown, in at least some embodiments, the microcapillaries may be evenly distributed within optical field adapter 200. FIG. 10F illustrates an embodiment in which eighteen smaller-diameter microcapillaries 202 are provided. Finally, FIG. 10G illustrates an embodiment wherein one or more voids 210 (e.g., noncircular shaped channels) are formed within optical field adapter 200. As stated, microcapillaries 202 may be similar to microcapillaries 140 and 141 described above with reference to FIG. 4. Example diameters for microcapillaries 202 may range from 3 to 100 μm, and in some embodiments from 10 to 40 μm. Other diameters may be used. In some embodiments, any of the optical fiber microcells described herein may employ one or more of the microcapillary and/or void configurations of FIGS. 10A-10G.

Microcapillaries 202 may be used to deliver a fluid to be analyzed into the main capillary 120 of embodiments of optical fiber microcell 10. Furthermore, in some embodiments, fluid can be delivered into and out of the main capillary hollow core 120C of optical fiber microcell 10 by using at least two fluid ports and connected microcapillaries or voids. When at least two microcapillaries or voids are implemented for delivery of fluid into and out of the hollow core 120C of main capillary 120 of an optical fiber microcell 10, at least one microcapillary (or void) can be implemented in the first optical field adapter 101 and the second microcapillary (or void) can be implemented in the second optical field adapter 104 (see, for example, fluid ports 102P and 105P, integrated fluid ports 130 and 131, and microcapillaries 102M, 105M, 110M, and 111M of FIGS. 1-4). A continuous flow of fluid through the hollow core 120C of the optical fiber microcell can be established by applying a pressure difference between the first and the second optical field adapter microcapillaries to enable, for example, on-line measurements of fluid optical properties.

With reference to FIGS. 1-4, in some embodiments, first and second optical field adapters 101 and/or 104 may employ a single-mode or nearly single mode core that supports propagation of a fundamental mode within the core. That is, the diameter of the core within each optical field adapter is larger than a core of the respective lead optical fiber coupled to the optical field adapter (as shown). For example, the mode field diameter of core 101C of first optical field adapter 101 is larger than the mode field diameter of core 100C of first lead optical fiber 100 and less than the diameter of the fundamental mode propagating within main capillary 120. Second optical field adapter 104 may be similarly configured.

Returning to FIG. 1, second lead optical fiber 103 has a first end 103A contiguously attached to second end 104B of second optical field adapter 104. As stated, in some embodiments, all optical fiber microcell constituent parts may be permanently bonded, made of glass, and/or fusion spliced, to form a monolith structure. Other material types and/or attachment techniques may be employed.

The first and second lead optical fibers 100 and 103 each have a respective core 100C and 103C and a respective cladding 100CL and 103CL and are configured to guide light to and from the optical fiber microcell 10. The first and second lead optical fibers 100 and 103 can be single-mode or multimode or polarization-maintaining. In some configurations, the first and second lead optical fibers 100 and 103 are single-mode or polarization-maintaining.

The first optical field adapter 101 expands the light wave (optical field) of the lead-in optical fiber (first lead optical fiber 100 as shown in FIG. 1), preferably to a diameter that is similar to inner diameter 122 of main capillary 120, as this minimizes the light transmission loss within main capillary 120. The second optical field adapter 104 refocuses or otherwise directs the light wave from the main capillary 120 back to the second lead optical fiber 103.

To maximize light transmission and minimize unwanted interface effects, when using highly-coherent lasers for interrogation of fluid optical properties, the preferred configurations may use single-mode lead optical fibers or polarization-maintaining single-mode lead fibers. When single-mode lead optical fibers are used to deliver light to and from main capillary 120, in some preferred cases, first optical field adapter 101 expands the optical field of first lead optical fiber 100 to a radial dimension that approaches or even matches the size of the fundamental mode of main capillary 120 as this minimizes total transmission losses of the entire microcell structure and minimizes excitation and propagation of spurious modes (e.g., higher order modes and modes that are guided by outer capillary wall 120W) within main capillary 120 of optical fiber microcell 10.

The main capillary 120 acts as a lossy waveguide filled with a fluid to be analyzed, which is optically assessed or analyzed as described further below. As described, in some embodiments, main capillary 120 can be an ordinary capillary having a solid wall 120W with an inner diameter 122 and an outer diameter 124. The optical losses per unit length of capillaries with a solid wall have been studied in detail theoretically in E. A. J. Marcatili and R. A. Schmeltzer, “Hollow metallic and dielectric waveguides for long distance optical transmission and lasers,” in The Bell System Technical Journal, vol. 43, no. 4, pp. 1783-1809, July 1964, doi: 10.1002/j.1538-7305.1964.tb04108.x. An increase in the inner diameter 122 of main capillary 120 reduces the losses per unit of capillary length of main capillary 120 but requires more substantial expansion and focusing of the light wave (optical field) by the first and second optical field adapters 101 and 104. Capillaries with large inner diameters also exhibit higher bend losses when curved. An example inner diameter 122 of main capillary 120 can range from 20 μm to 1 mm in some embodiments, from 50 μm to 700 μm in other embodiments, and from 65 μm to 300 μm in other embodiments. A typical length of a main capillary may be between 300 μm and 10 m in some embodiments, between 1 mm and 5 m in other embodiments, and between 5 mm and 1 m in other embodiments. The main downside of using a large length for main capillary 120 is in reduced bend tolerance of the capillary, which requires the main capillary to be reasonably straight to maintain low optical transmission losses of the entire microcell structure.

Optical losses per unit of length of the main capillary and bend tolerance can, however, be improved by forming microcapillaries or other voids within the wall 120W of main capillary 120. For example, FIGS. 11A-11C illustrate schematic cross-sectional views of different main capillary designs according to embodiments provided herein. In FIG. 11A, main capillary 120 has no microcapillaries or voids within wall 120W defined by inner diameter 122 and outer diameter 124. In FIG. 11B, wall 120W of main capillary 120 has one or more microcapillaries 126 formed therein, whereas, in FIG. 11C, wall 120W of main capillary 120 has longitudinal channels or voids 128 within wall 120W of the main capillary 120. In some embodiments, microcapillaries 126 and/or voids 128 may be evenly distributed/spaced from one another (e.g., symmetrically spaced) and/or extend an entire length of main capillary 120. Fewer or more microcapillaries and/or voids may be employed within wall 120W of main capillary 120. It shall be emphasized that proper selection of main capillary dimensions, i.e., inner diameter 122 and outer diameter 124 as shown in FIG. 11A, retains reasonably low optical losses of the microcell structure. A simple geometry for the main capillary makes manufacturing, preparation, and splicing of a fiber microcell simple, efficient, and straightforward. Microcapillaries 126 and/or voids 128 may be formed by drilling or milling of holes or other shapes into a substrate tube, which is used for capillary manufacturing. For example, ultrasonically actuated diamond drill bits or miniature diamond mills may be used to drill or mill deep holes into the walls of a tube made from pure silica. Then, such a drilled tube may be drawn into a capillary using a conventional fiber drawing process (e.g., employing a draw tower and high temperature fiber draw furnace). Other microcapillary and/or void formation techniques may be employed.

When microcapillaries 126 have a circular cross-section (as shown in FIG. 11B), the diameter of the microcapillaries may be substantially smaller than the inner diameter of main capillary 120 (e.g., inner diameter 122 in FIG. 11A). For example, in some embodiments, microcapillary diameters (for microcapillaries 126) may be between ⅓ and 1/15 of the central void diameter (e.g., diameter 122). For typical dimensions of main capillary 120 this would yield microcapillaries with diameters between 5 and 50 μm. Other dimensions may be employed for microcapillaries 126.

The first and second optical field adapters 101 and 104 can use the same optical designs and/or can be embodied in different ways. The main function of optical field adapters according to one or more embodiments is to adapt or convert radial dimensions of the light waves (optical fields) propagating in the lead optical fibers to a radial dimension (e.g., diameter) of the optical field that is most efficiently guided by the main capillary, thereby minimizing optical losses of the entire microcell structure. Thus, optical field adapters perform functions of expanding and focusing of the light propagating within the microcell structure.

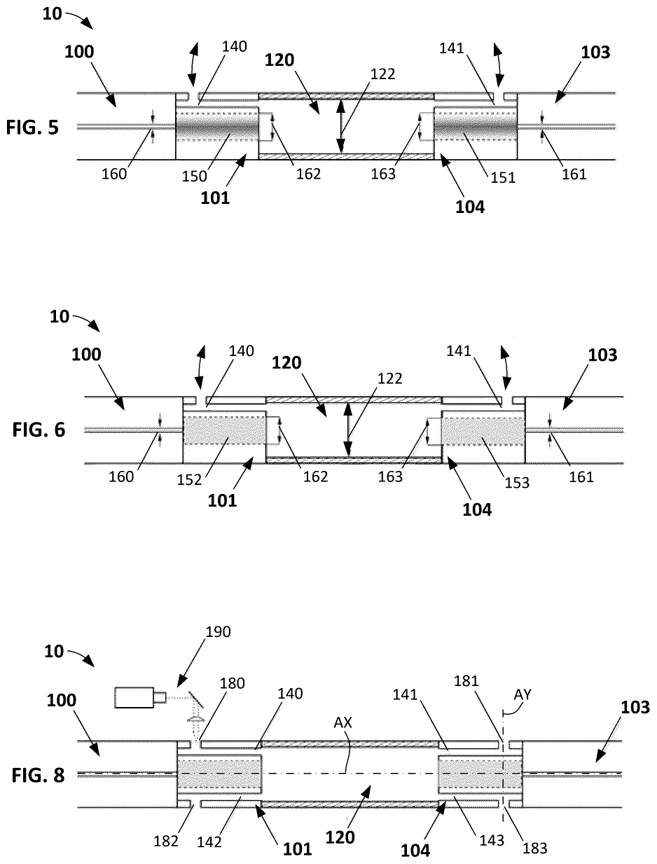

For example, referring to FIGS. 5-7, the first optical field adapter 101 expands the radial dimension 160 of a modal field of the first lead optical fiber 100 to a diameter 162 that is comparable to (or closer to) the inner diameter 122 of the main capillary 120, while the second optical field adapter 104 focuses the light wave received from the main capillary 120 to the radial diameter 163 corresponding approximately to (or closer to) the diameter 161 of the mode propagating in the second lead optical fiber 103. Example dimensions for diameters 160 and/or 161 range from 2-15 μm in some embodiments, and from 4.5-10 μm in other embodiments. Example dimensions for diameters 162 and/or 163 range from 15-60 μm in some embodiments, and from 25-35 μm in other embodiments.

In some embodiments, the optical field diameter of the expanded optical field from first optical field adapter 101 may correspond to about 70% to 75% of the capillary inner diameter (e.g., diameter 122 of main capillary 120). This can be seen if it is considered that all guided modes within the capillary have zero electric fields at the inner surface of the capillary wall and that the electric field amplitude of the fundamental mode (E_{H11}) follows the Bessel function of the first kind of order zero J₀, given by equation (1):

$$E ( r ) = {E}_{0} {J}_{0} ( 2.405 * \frac{r}{a} ) \qquad ( 1 )$$

where E(r) is the modal electric field amplitude at a radial distance r from the capillary's center, E₀ is the electric field amplitude at the center of the capillary (r=0), and a is the inner radius of the capillary (for details see E. A. J. Marcatili and R. A. Schmeltzer, “Hollow metallic and dielectric waveguides for long distance optical transmission and lasers,” in The Bell System Technical Journal, vol. 43, no. 4, pp. 1783-1809, July 1964, doi: 10.1002/j.1538-7305.1964.tb04108.x). By assuming a Gaussian launching field distribution and definition of the mode field diameter (MFD), which requires that:

$$E ( \frac{MDF}{2} ) = \frac{{E}_{0}}{e} , \qquad ( 2 )$$

the optimum mode field diameter that preferentially launches the fundamental mode can be found by setting:

$$\frac{E ( r = \frac{MFD}{2} )}{{E}_{0}} = \frac{1}{e} \approx 0.368 , \qquad ( 3 )$$

corresponding to:

$${J}_{0} ( 2.405 * \frac{MFD}{2 a} ) = \frac{1}{e} \approx 0.368 \qquad ( 4 )$$

Solving this equation yields MFD≈0.72*2a. Thus, the optimal field diameter of the launching field should be approximately 72% of the main capillary's inner diameter. However, even smaller field diameters can already provide efficient launch and guidance of light received into the main capillary. The latter configuration might be advantageous to provide space required to accommodate integration of microcapillaries (or other voids) into the optical field adapter.

There are different possibilities for the implementation of optical field adapters with fluid delivery microcapillaries. For example, as shown in FIG. 5, the optical field adapters 101 and 104 can each include a short section of optical fiber with cores 150 and 151, respectively, having graded index profiles as well as side microcapillaries 140 and 141, respectively. Alternatively, optical field adapters 101 and 104 may include sections of coreless fibers followed by sections of fibers with a graded index profile and side capillaries (or other voids) to form a graded index (GRIN) lens collimating assembly with fluid delivery to main capillary 120. In this case, the length of the fiber with a graded index profile may be precisely trimmed to a distance that provides focusing and collimation at the desired wavelength.

A GRIN lens is an optical device with a refractive index that varies gradually in radial direction within the lens material, allowing it to focus or collimate light without curved surfaces. GRIN lenses bend light through a continuous gradient, often following a parabolic profile. Chemical vapor deposition or diffusion techniques can be used to create the desired index profile during manufacturing. Chemical vapor deposition can utilize the same process that is used in multimode telecom fiber manufacturing, by drawing of the deposited preform into a fiber structure. Typical maximum difference in a refractive index between the center and the edge of the GRIN lens can be in the range between 1-38, but other values are also possible.

Optical field adapters can be efficiently formed by bonding together single or multiple short sections of single-mode fibers with progressively larger fundamental mode field diameters 162 and 163. FIG. 6 illustrates an embodiment of optical fiber microcell 10 that is similar to the embodiment of FIG. 4, but without integrated fluid ports 130 and 131, that employs a single short section of single-mode fiber for each optical field adapter (e.g., core 152 with mode field diameter 162 for first optical field adapter 101 and core 153 with mode field diameter 163 for second optical field adapter 104). Such an embodiment without integrated fluid ports may be employed in applications in which optical fiber microcell 10 is filled with fluid and then sealed so that it does not need to be connected to a fluid delivery system (after filling). After filling, interrogation of fluid parameters may be performed with the fluid sealed within main capillary 120 (e.g., to measure an external electric field with a liquid sensitive to electric fields).

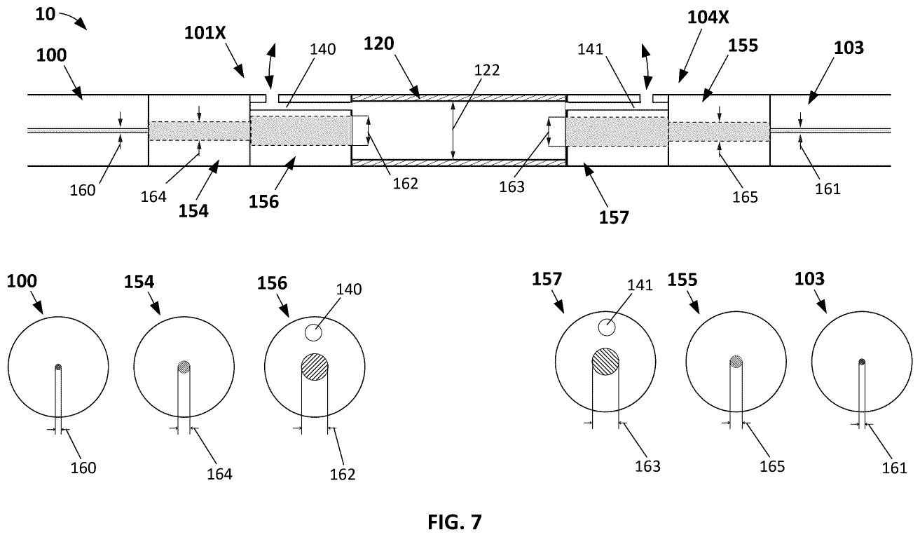

As another example, when a single-mode optical fiber is used as a lead optical fiber, the all-fiber collimators (e.g., first and second optical field adapters 101 and 104) can be constructed as a sequence of two or more optical fibers with progressively larger mode field diameters. For example, FIG. 7 illustrates an embodiment of optical fiber microcell 10 in which a first optical field adapter 101X is formed from a first fiber section 154 and second fiber section 156 having single-mode cores supporting fundamental modes with mode field diameters 164 and 162, respectfully. As shown, mode field diameter 164 of first fiber section 154 is larger than the core diameter 160 of first lead optical fiber 100, and mode field diameter 162 of second fiber section 156 is larger than mode field diameter 164 of first fiber section 154. As further shown in FIG. 7, optical fiber microcell 10 may include a second optical field adapter 104X formed from a third fiber section 155 and fourth fiber section 157 having single-mode cores supporting fundamental modes with mode field diameters 165 and 163, respectfully. As shown, mode field diameter 165 of third fiber section 155 is larger than the core diameter 161 of second lead optical fiber 103, and mode field diameter 163 of fourth fiber section 157 is larger than mode field diameter 165 of third fiber section 155. In the embodiment shown, second fiber section 156 and fourth fiber section 157 include microcapillaries 140 and 141, respectively, for coupling fluid to main capillary 120. In some embodiments, microcapillaries 140 and 141 may extend into first fiber section 154 and/or third fiber section 155, respectively, and, in some embodiments, even into first lead optical fiber 100 and/or second lead optical fiber 103, respectively.

Example dimensions for diameters 160 and/or 161 range from 2-15 μm in some embodiments, and 4.5-12 μm in other embodiments. Example dimensions for diameters 162 and/or 163 range from 15-60 μm in some embodiments, and 25-35 μm in other embodiments. Example dimensions for diameters 164 and 165 range from 8-25 μm in some embodiments, and 10-18 μm in other embodiments. Other dimensions may be employed.

In this case, the lengths of the individual fiber sections that form the optical field adapters are not critical and can have arbitrary lengths, typically between less than a few millimeters and more than a meter if so desired. Longer lengths of optical field adapter fibers might be particularly convenient as the fluid delivery microcapillaries are integrated within at least one of the optical field adapters. In this case, the connection between the fluid delivery microcapillaries and the fluid delivery system may be located at a considerable distance from main capillary 120. This is of special interest when the main capillary containing the observable fluid needs to be exposed to external fields, such as strong magnetic or electric fields that can adversely affect components of an external fluid delivery system or when any small outer diameter of the structure is of high importance and dimensions of the fluid delivery system might present additional volume or size limitations.

As stated, in some embodiments, the entire optical fiber microcell can be made from silica or doped silica glass and can be preferably fusion-spliced to form a monolithic fiber-like assembly. In further embodiments, optical fiber microcells can have a substantially constant outer diameter, which can be similar to standard telecom optical fiber dimensions to allow very compact system designs and use of very low volumes of fluids.

The introduction of fluid, which can be gas, liquid, or vapor, can be accomplished by different means, depending on the intended use of the optical fiber microcell.

One possibility, as shown in FIG. 1, includes fluid ports in one or both optical field adapters 101 and 104 (e.g., fluid port 102P in optical field adapter 101 and fluid port 105P in optical field adapter 104). In some embodiments, as shown in FIGS. 2 and 4, integrated fluid ports 130 and 131, such as external tubing connection locations, may be employed. In this manner, a fluid may be delivered to hollow core 120C of main capillary 120 via the first, second, or both optical field adapters 101 and 104. Microcapillaries for fluid delivery to hollow core 120C can be created in different ways, e.g., by femtosecond inscription of one or more microchannels connecting front and side surfaces of an optical field adapter, followed by selective etching as described, for example, in Hermans, Martin & Gottmann, Jens & Riedel, Frank. (2014). Selective, Laser-Induced Etching of Fused Silica at High Scan-Speeds Using KOH. Journal of Laser Micro/Nanoengineering. 9. 10.2961/jlmn.2014.02.0009. and Hnatovsky, Cyril & Taylor, R. & Simova, Eli & Bhardwaj, Vinayak & Rayner, D. & Corkum, P. (2005). Polarization-selective etching in femtosecond laser-assisted microfluidic channel fabrication in fused silica. Optics Letters. 30. 1867-1869. 10.1364/OL.30.001867.

Another convenient method for forming an optical field adapter such as optical field adapter 101 or 104 includes the preparation of optical fibers with increased mode field diameters (e.g., a larger core diameter than the core of the lead optical fibers) and integrated microcapillaries. In this case, the optical fiber with an increased mode field diameter can include one or more microcapillaries 140 and 141, as described above with reference to FIG. 4, that are located between the fiber core and the fiber outer surface.

To provide easier fiber manufacturing and easier splicing of the microcell structure, manufacturing fibers with two or more microcapillaries distributed equidistantly around the fiber core may be a preferred solution over a fiber with a single microcapillary as it may prevent fiber bending due to an uneven frozen stress in non-symmetric fiber designs. See, for example, microcapillaries 102M, 105M, 110M, and 111M of FIG. 3 and microcapillaries 202 of FIGS. 10B-10F. It should be noted that multiple microcapillaries 202 (of FIGS. 10B-10F) integrated into the fibers can provide higher fluid through-flow in optical field adapters or more sophisticated functions, like delivering different fluids or combinations of different fluids into the main capillary 120 of optical fiber microcell 10. The microcapillary or microcapillaries integrated within an optical field adapter can also be extended into the lead optical fibers by providing lead optical fibers with integrated microcapillaries having the same geometrical distribution as capillaries within the optical fiber or fibers forming the optical field adapter. If an optical field adapter is constructed from multiple fiber segments, one or all segments can incorporate microcapillaries, but in most cases only the fiber segment that is connected to the main capillary 120 contains fluid delivery microcapillaries as this segment can be of arbitrary length and can in most cases provide convenient connection to a fluid delivery system by creating fluid ports (e.g., access holes) to these capillaries from the side.

To allow connection of microcapillaries to the fluid delivery system, in some embodiments, microcapillaries may be accessed from the side of the fiber, e.g., as shown in FIG. 8, wherein fluid port 180 or fluid ports 180 and 182 are on one side of the main capillary 120 and/or fluid port 181 or fluid ports 181 and 183 are on the other side of the main capillary 120, each port having an axis AY approximately perpendicular to the optical fiber/microcell central axis AX. These fluid ports are relatively shallow, and can be created in various ways using, for example, micro-drilling by application of a femtosecond laser 190, focused ion-beam, or even mechanical microdrills or side cutting. Other methods may include local etching, for example, by applying hydrofluoric acid or gas etching over a short length of fiber containing microcapillaries. Fluid to be analyzed is delivered through a fluid port and microcapillary connected to the hollow core 120C of the main capillary 120. By creating multiple microcapillaries 202 (see FIGS. 10B-10F) in a single optical field adapter or at least one capillary in both optical field adapters, an efficient flow of fluid can be established through the fiber microcell as shown in FIGS. 10A-10G. Microcapillaries can also have different shapes, e.g., they can be round, oval, square, or otherwise-shaped, have different diameters, or the like (e.g., such as voids 210 in FIG. 10G).

Fluid ports (e.g., side openings) that allow access to microcapillaries can be connected to a fluid delivery system in various ways, for example, such as by fusion splicing or by connecting another fluid delivery capillary to the opening in a direction wherein the light guiding fiber and delivery capillary are mutually perpendicular. As shown in FIG. 12, a fluid delivery capillary 300 or 301 (e.g., having a diameter larger than a lead optical fiber 100 or 103) can be closed on one side (the bottom side as shown in FIG. 12) by splicing or applying a special adhesive 302 or 303. Thereafter, an opening may be formed in a side of the fluid delivery capillary 300 or 301 (e.g., by drilling, etching, or the like) and an optical field adapter 101 or 104 (including an optical fiber containing microcapillaries and fluid ports) may be placed into the opening of the fluid delivery capillary 300 or 301. The sealing of the microcell structure (e.g., to fixedly couple the fluid delivery capillary 300 or 301 to optical field adapter 101 or 104) can be achieved either through a fusion process or by covering the region where the optical field adapter and the delivery capillary intersect with a high viscosity adhesive 304 that does not penetrate and jam the fluid delivery capillary. Suitable adhesives for any of the above applications are available from Master Bond, Inc. of Hackensack, NJ, for example (e.g., adhesives compatible with glass and the fluids to be analyzed).

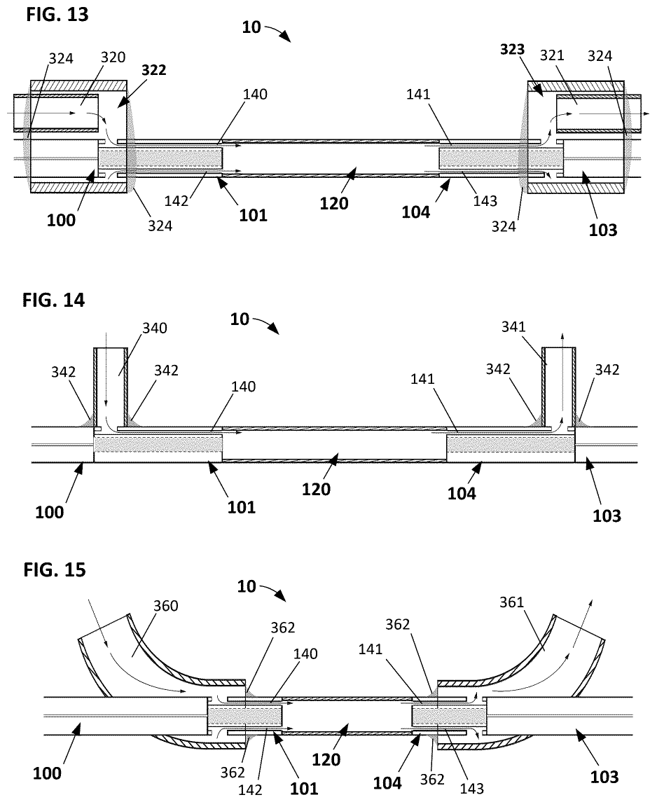

Alternatively, as shown in FIG. 13, fluid delivery capillaries 320 and 321 may be fluidly connected to microcapillaries 140-143 by encapsulating a short section of optical field adapters 101 and 104 (e.g., each a fiber containing microcapillaries with a side-opening fluid port) into short section, large-diameter capillaries 322 and 323. That is, capillary 322 is large enough to contain both fluid delivery capillary 320 and first optical field adapter 101 and capillary 323 is large enough to contain both fluid delivery capillary 321 and second optical field adapter 104). Sealing can be accomplished with a high viscosity adhesive 324 or a well-controlled fusion process.

In addition to fiber with integrated microcapillaries and fluid ports, additional smaller diameter fluid delivery capillaries 340 and 341 can be attached to optical field adapters 101 and 104 as shown in FIG. 14. Specifically, fluid delivery capillary 340 may couple to first optical field adapter 101 so as to deliver fluid to microcapillary 140 and fluid delivery capillary 341 may couple to second optical field adapter 104 so as to deliver fluid to microcapillary 141. This microcell structure can also be sealed on the sides either by a fusion process or by applying a suitable adhesive 342. The fluid of interest is then delivered firstly through the smaller diameter fluid delivery capillary 340 and/or 341 and further into microcapillaries of optical field adapter 101 (and/or the lead optical fiber 100) and then finally to main capillary 120.

Alternatively, as shown in FIG. 15, a large diameter capillary 360 or 361 can be curved while inserting an optical fiber containing microcapillaries with fluid ports (e.g., optical field adapters 101 and 104) through the curved regions into the large diameter capillary 360 or 361. Large diameter capillaries 360 or 361 may have a slightly larger inner diameter than an outside diameter of lead optical fiber 100 or 103, for example. Sealing between each large diameter capillary and an optical fiber (e.g., lead optical fiber 100 or 103) can also be accomplished by using high viscosity adhesive 362 or a well-controlled fusion process. The large diameter capillaries 360 and 361 can then serve as a fluid delivery system to microcapillaries 140 and 141 (and thus main capillary 120).

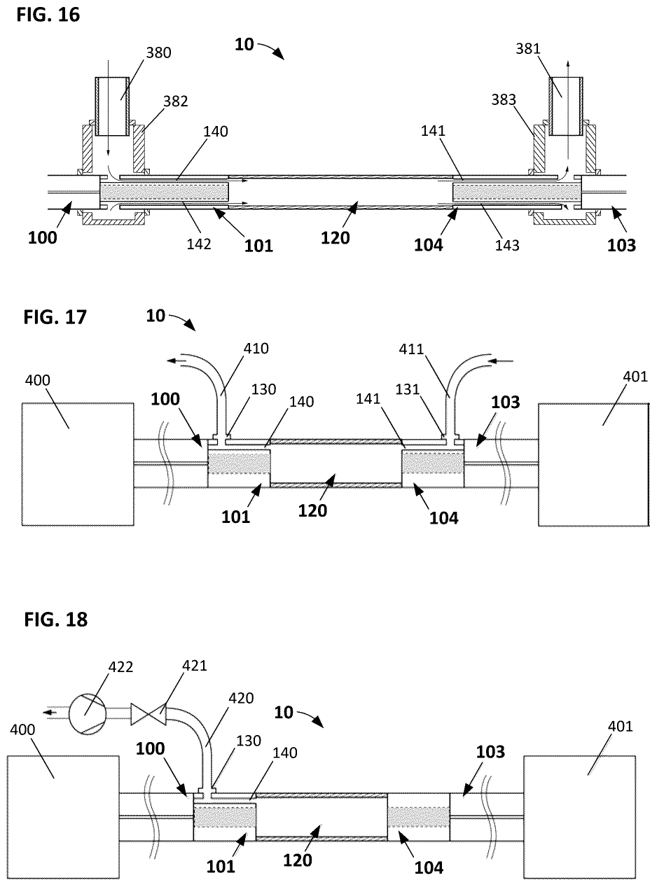

As shown in FIG. 16, another possible embodiment for coupling a fluid delivery system with an optical fiber microcell is to mount first and second optical field adapters 101 and 104 (e.g., optical fibers with microcapillaries 140-143 and fluid ports) and fluid delivery capillaries 380 or 381 or other tubes into a small chamber 382 or 383, respectively, that can be made with any other suitable material (e.g., amorphous SiO2 or another material). Other variants or solutions that allow fluid coupling into fluid ports connected to fiber microcapillaries for delivery of fluids in and out of the microcapillaries are possible.

In some embodiments, a fluid of interest can be introduced into the hollow core 120C of a main capillary 120 once, during device manufacturing, followed by permanent sealing of fluid delivery microcapillaries or other fluid delivery voids. In other embodiments, an optical fiber microcell can be used for continuous analysis of fluids wherein a fluid is continuously or occasionally exchanged within the main capillary 120 through microcapillaries (or other voids) integrated into optical field adapters as described above.

Light in the main capillary may continuously escape and couple into the sidewalls of the main capillary (e.g., wall 120W in FIG. 1) and thus may form a set of modes that propagate independently from the main mode that propagates in the center of the main capillary. Similarly, imperfect mode matching between the expanded fields can launch multiple modes that are guided by the main capillary outer surface. These spurious modes can form weak interference beating patterns with the main/fundamental mode of the main capillary, which can reduce signal integrity. These spurious modes can be removed by covering the main capillary with index matching or higher index material or an absorbing layer. Thus, covering part of or all of main capillary 120 with higher index material or an absorbing layer may be a desired feature that improves signal integrity, especially in cases where highly coherent tunable lasers are used for analysis of fluid properties.

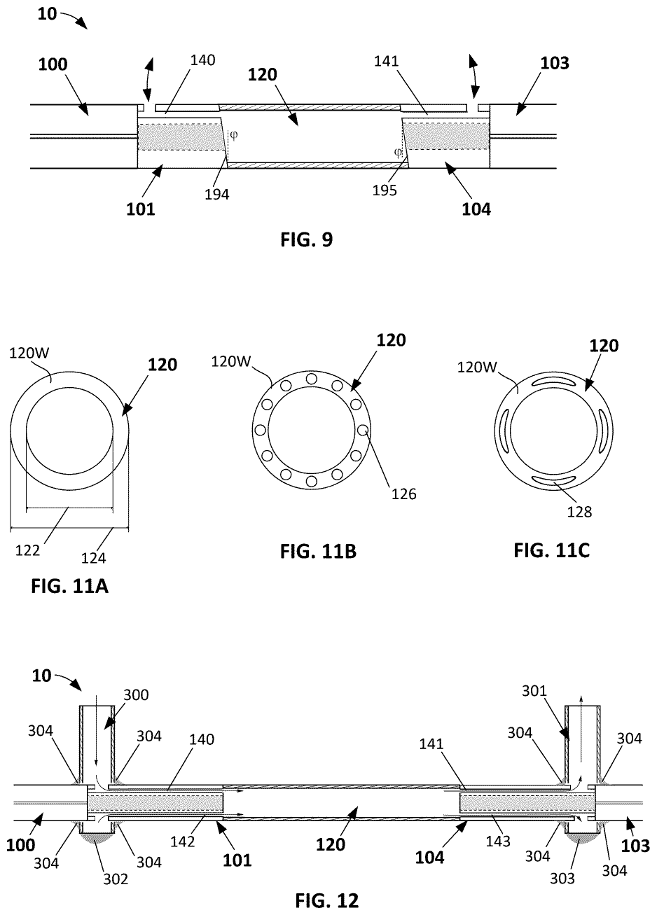

Another source of a deterministic interference in the present setup can arise from formation of a low-finesse Fabry-Perot cavity between both optical field adapters (e.g., first and second optical field adapters 101 and 104). The appearance of Fabry-Perot interference can result in sinusoidal modulation of the transfer spectral characteristics, which can degrade overall signal integrity. To reduce the appearance of this Fabry-Perot interference to negligible levels, coupling of light that is back-reflected from frontal surfaces of optical field adapters into the main capillary should be prevented. As shown in FIG. 9, in some embodiments, this can be achieved efficiently by limited tilting of surface 194 of optical field adapter 101, surface 195 of optical field adapter 104, or both surfaces 194 and 195 (as shown by angle φ). Since a propagating light wave (optical field) is expanded by optical field adapter 101 to a substantial diameter before entering the main capillary 120, this tilt can be limited. In most cases, 0.5 to 5 degrees of tilting of one or both of optical field adapter surfaces 194 and/or 195 can reduce the adverse effects of Fabry-Perot interference to negligible levels. These low to moderate tilts do not compromise the ability to assemble the microcell structure by a fusion-splicing process.

In most embodiments, optical fiber microcells are used for analysis of optical properties of fluids that are delivered into the main capillary. Determination of optical absorption or optical spectral absorption within a limited band of optical frequencies within the fluid of interest is the most obvious application of the optical fiber microcells disclosed herein. Embodiments of optical fiber microcells disclosed herein can be used to measure optical absorption or optical spectral absorption of gases, vapors, and liquids. Applications of these measurements are broad and include gas and liquid spectroscopy, including tunable laser spectroscopy methods in UV (ultraviolet), VIS (visible) and IR (infrared) ranges. Other applications of optical fiber microcells include quantum applications, including magnetic and electric field measurement through spectroscopic or polarimetric evaluation of metal vapors and vapors of liquids or certain gases. The latter application may further include moderate or even extensive heating of the optical fiber microcell, which can be achieved using a high-power laser coupled through lead optical fibers. Light having multiple wavelengths can also be delivered into the optical fiber microcell to allow for setups that use atoms in excited states, such as Rydberg atoms. Some of these configurations can use fluids with constant compositions, meaning that the system is filled and sealed, while in other cases the fluid is continuously circulated through the optical fiber microcell assembly. Relatively large diameters of the main capillary and short lengths of microcapillaries or openings needed for fluid exchange can provide reasonably short exchange times at moderate pressure differences.

Embodiments of spectroscopic applications are shown in FIGS. 17-19 below. With reference to FIG. 17, a light source 400 such as a laser, LED, white light source, etc., is positioned to deliver a light wave to first lead optical fiber 100. This light wave travels through first optical field adapter 101 into main capillary 120 and through any fluid located therein. The light wave then travels through second optical field adapter 104 into second lead optical fiber 103 and is detected by an optical detector 401. Fluid to be analyzed may be delivered into main capillary 120 through microcapillary 141 of second optical field adapter 104 using a fluid delivery connection link 411 coupled to integrated port 131. Fluid may be removed from main capillary 120 through microcapillary 140 of first optical field adapter 101 using a fluid delivery connection link 410 coupled to integrated port 130.

In the embodiment of FIG. 18, the second optical field adapter 104 does not include a microcapillary. Fluid may be removed from main capillary 120 through microcapillary 140 of first optical field adapter 101 using a fluid delivery connection link 420 coupled to integrated port 130 and a vacuum pump 422 via a valve 421. The embodiment of FIG. 18 may be used to adjust an amount of fluid (e.g., liquid, gas, or vapor) within main capillary 120 which is sealed when valve 421 is closed. In this process, for example, main capillary 120 can be initially evacuated by using vacuum pump 422. After evacuating main capillary 120, a small amount of fluid can be returned into main capillary 120 by transiently connecting target fluid to the evacuated port (e.g., integrated fluid port 130). The evacuation can then be repeated, but only until the target fluid pressure is reached (e.g., within main capillary 120). The fluid delivery system can be omitted from the setup (as shown) when fluid with constant composition is used, as for example in most quantum sensing applications, once the fluid is introduced into the main capillary.

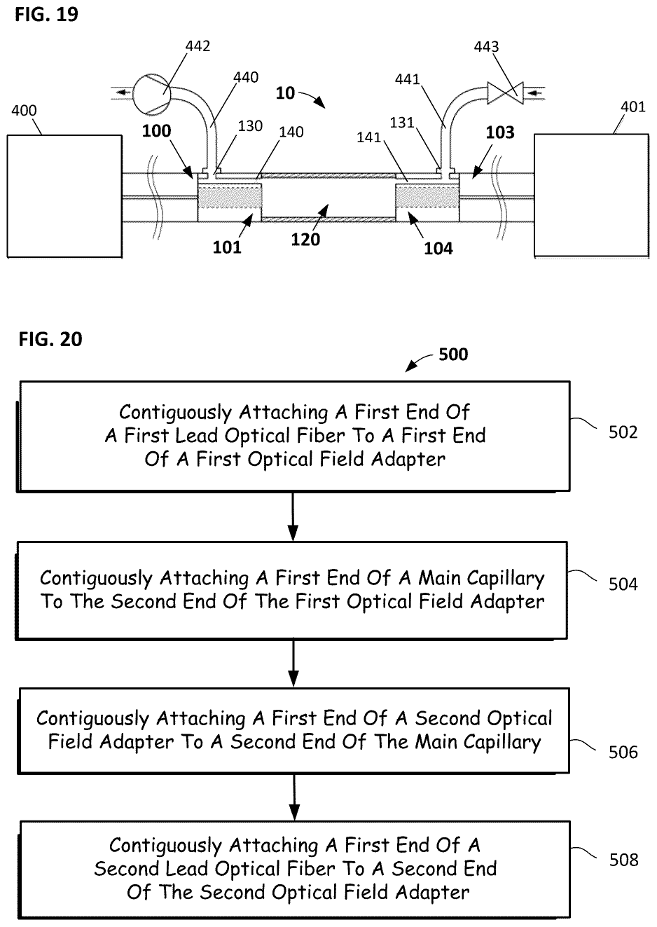

In the embodiment of FIG. 19, fluid to be analyzed may be delivered into main capillary 120 through microcapillary 141 of second optical field adapter 104 using a fluid delivery connection link 441 coupled to integrated port 131. The fluid source (not separately shown) may be isolated from fluid deliver connection link 441 using a valve 443. Fluid may be removed from main capillary 120 through microcapillary 140 of first optical field adapter 101 using a fluid delivery connection link 440 coupled to integrated port 130 and pump 442. Other configurations may be employed.

FIG. 20 illustrates a method 500 of assembling an optical fiber microcell for optical analysis of fluid according to one or more embodiments. At process block 502, method 500 may begin by contiguously attaching a first end of a first lead optical fiber to a first end of a first optical field adapter. The first optical field adapter may have an optical fiber configured to expand a light wave received from the first lead optical fiber and to guide the expanded light wave through a second end of the first optical field adapter.

At process block 504, method 500 may include contiguously attaching a first end of a main capillary to the second end of the first optical field adapter. The main capillary may have a hollow core, which has an inner diameter.

At process block 506, method 500 may include contiguously attaching a first end of a second optical field adapter to a second end of the main capillary.

And at process block 508, method 500 may include contiguously attaching a first end of a second lead optical fiber to a second end of the second optical field adapter.

In some embodiments, method 500 may further include process blocks (not shown) that include, e.g., (1) receiving the fluid in the hollow core of the main capillary via a fluid port and a microcapillary in the first optical field adapter, the microcapillary in fluid communication with the hollow core; and/or (2) a method of using the optical fiber microcell assembled via method 500 that includes expanding a light wave in the first optical field adapter received from the first lead optical fiber, and guiding the expanded light wave into the main capillary. The method of using the optical fiber microcell assembled via method 500 may also include focusing a light wave received in the second optical field adapter from the main capillary to the second lead optical fiber, analyzing an optical response of the fluid in response to receiving a light wave from the second lead optical fiber, and/or removing the fluid from the main capillary via a fluid port and a microcapillary in the second optical field adapter, the fluid port in fluid communication with the microcapillary, and the microcapillary in fluid communication with the hollow core of the main capillary.

While this disclosure is susceptible to various modifications and alternative forms, specific method and apparatus embodiments have been shown by way of example in the drawings and are described in detail herein. It should be understood, however, that the particular methods and apparatus disclosed herein are not intended to limit the disclosure or the following claims.

What is claimed is:

1. An optical fiber microcell for optical analysis of a fluid, comprising:
a first lead optical fiber having a first end and a core;
a first optical field adapter having a first end and a second end, the first end of the first optical field adapter contiguously attached to the first end of the first lead optical fiber;
a main capillary having a first end contiguously attached to the second end of the first optical field adapter, the main capillary also having a second end and a hollow core, the hollow core having an inner diameter;
a second optical field adapter having a first end and a second end, the first end contiguously attached to the second end of the main capillary; and
a second lead optical fiber having a first end and a core, the first end of the second lead optical fiber contiguously attached to the second end of the second optical field adapter; wherein:
the first lead optical fiber is configured to guide a light wave into the first optical field adapter;
the first optical field adapter is configured to expand and guide the light wave received from the first lead optical fiber into the main capillary;
the main capillary is configured to contain in the hollow core a fluid to be analyzed; and
the second optical field adapter is configured to focus light received from the main capillary into the core of the second lead optical fiber.

2. The optical fiber microcell of claim 1, wherein the first optical field adapter includes one or more fluid delivery ports for receiving the fluid to be analyzed, the one or more fluid delivery ports in fluid communication via a microcapillary with the hollow core of the main capillary.

3. The optical fiber microcell of claim 1, wherein the first and second lead optical fibers, the first and second optical field adapters, and the main capillary are permanently bonded via fusion splicing to form a monolithic structure.

4. The optical fiber microcell of claim 1, wherein the fluid to be analyzed comprises a gas, a liquid, a vapor, or a gas containing a vapor.

5. The optical fiber microcell of claim 1, wherein the first optical field adapter comprises an optical fiber having a fundamental mode field diameter larger than a fundamental mode field diameter of the first lead optical fiber and smaller than the inner diameter of the main capillary.

6. The optical fiber microcell of claim 1, wherein the first optical field adapter comprises a sequence of two or more optical fibers having progressively larger fundamental mode field diameters, wherein:
a first of the two or more optical fibers having the smallest fundamental mode field diameter attaches to the first lead optical fiber;
a second of the two or more optical fibers having the largest fundamental mode field diameter attaches to the main capillary;
the smallest fundamental mode field diameter of the first of the one of the two or more optical fibers is larger than a fundamental mode field diameter of the first lead optical fiber; and
the largest fundamental mode field diameter of the second of the two or more optical fibers is smaller than the inner diameter of the main capillary.

7. The optical fiber microcell of claim 1, wherein the first optical field adapter comprises an optical fiber having a core with a graded index profile.

8. The optical fiber microcell of claim 1, wherein the first or second optical field adapter comprises an optical fiber having a core and outer edge, and one or more longitudinal microcapillaries located between the core and the outer edge.

9. The optical fiber microcell of claim 8, wherein the one or more longitudinal microcapillaries extend in parallel with an optical fiber/microcell central axis over part of or an entire length of the first or second optical field adapter.

10. The optical fiber microcell of claim 8, wherein the first or second lead optical fiber comprises one or more longitudinal microcapillaries located between the core of the first or second lead optical fiber and an outer edge of the first or second lead optical fiber that connect respectively to the one or more longitudinal microcapillaries of the first or second optical field adapter.

11. The optical fiber microcell of claim 1, wherein the main capillary includes a wall having multiple microcapillaries extending in a direction of a central axis of the main capillary over at least a portion of a length of the main capillary.

12. A method of assembling an optical fiber microcell for optical analysis of a fluid, the method comprising:
contiguously attaching a first end of a first lead optical fiber to a first end of a first optical field adapter, the first optical field adapter having an optical fiber configured to expand a light wave received from the first lead optical fiber and guide the expanded light wave through a second end of the first optical field adapter;
contiguously attaching a first end of a main capillary to the second end of the first optical field adapter, the main capillary having a hollow core, the hollow core having an inner diameter;
contiguously attaching a first end of a second optical field adapter to a second end of the main capillary; and
contiguously attaching a first end of a second lead optical fiber to a second end of the second optical field adapter.

13. The method of claim 12 further comprising receiving the fluid in the hollow core of the main capillary via a fluid port and a microcapillary in the first optical field adapter, the microcapillary in fluid communication with the hollow core.

14. The method of claim 12, wherein the first optical field adapter comprises an optical fiber having a fundamental mode field diameter larger than a fundamental mode field diameter of the first lead optical fiber and smaller than the inner diameter of the main capillary.

15. The method of claim 12, wherein the first optical field adapter comprises a sequence of two or more optical fibers having progressively larger fundamental mode field diameters, wherein:
a first of the two or more optical fibers having the smallest fundamental mode field diameter attaches to the first lead optical fiber;
a second of the two or more optical fibers having the largest fundamental mode field diameter attaches to the main capillary;
the smallest fundamental mode field diameter of the first of the one of the two or more optical fibers is larger than a fundamental mode field diameter of the first lead optical fiber; and
the largest fundamental mode field diameter of the second of the two or more optical fibers is smaller than the inner diameter of the main capillary.

16. The method of claim 12 wherein the first optical field adapter comprises an optical fiber having a core with a graded index profile.

17. The method of claim 12 wherein the first or second optical field adapter comprises an outer edge, an optical fiber having a core, and one or more longitudinal microcapillaries located between the core and the outer edge.

18. A method of using the optical fiber microcell of claim 1, comprising:
expanding a light wave in the first optical field adapter received from the first lead optical fiber; and
guiding the expanded light wave into the main capillary.

19. The method of claim 18 further comprising focusing a light wave received in the second optical field adapter from the main capillary to the second lead optical fiber.

20. The method of claim 19 further comprising analyzing an optical response of the fluid in response to receiving a light wave from the second lead optical fiber.

21. The method of claim 18 further comprising removing the fluid from the main capillary via a fluid port and a microcapillary in the second optical field adapter, the fluid port in fluid communication with the microcapillary, and the microcapillary in fluid communication with the hollow core of the main capillary.
